(19) United States
(12) Patent Application Publication
(10) Pub. No.: US 2025/0299898 A1
(43) Pub. Date: Sep. 25, 2025

(54) ELECTROMAGNETIC RELAY DEVICE

(71) Applicants: DENSO CORPORATION, Kariya-city (JP); DENSO ELECTRONICS CORPORATION, Anjo-city (JP)

(72) Inventors: Ryota KUNIYOSHI, Kariya-city (JP); Tomohiro YASUDA, Kariya-city (JP); Shingo KURITA, Kariya-city (JP); Hiroshi NAGURA, Anjo-city (JP)

(73) Assignees: DENSO CORPORATION, Kariya-city (JP); DENSO ELECTRONICS CORPORATION, Anjo-city (JP)

(21) Appl. No.: 19/229,122

(22) Filed: Jun. 5, 2025

Related U.S. Application Data
(63) Continuation of application No. PCT/JP2023/038939, filed on Oct. 27, 2023.

(30) Foreign Application Priority Data
Dec. 5, 2022 (JP) 2022-194255

(51) Int. Cl. H01H 50/18; H01H 50/36

(52) U.S. Cl. CPC H01H 50/18; H01H 50/36

(57) ABSTRACT

In an electromagnetic relay device, a plunger causes a movable member to reciprocate to cause a movable contact to abut onto or separate from a stationary contact. A solenoid unit includes an electromagnetic coil, a stationary core, and a movable core. The stationary core includes a plate member located in front of the electromagnetic coil. The plate member is arranged to overlap the electromagnetic coil when viewed in a reciprocation direction of the plunger. The stationary core has a stationary inside portion located inside the electromagnetic coil. The plate member and the stationary inside portion are integrated with each other. The stationary core has a joint surface between the outer peripheral surface of the stationary inside portion and the rear-side surface of the plate member. The joint surface is curved convexly with respect to the plunger to constitute a stationary curved surface.

### CROSS-REFERENCE TO RELATED APPLICATION

This application is a bypass continuation-in-part application of currently pending international application No. PCT/JP2023/038939 filed on Oct. 27, 2023 designating the United States of America, the entire disclosure of which is incorporated herein by reference, the international application being based on and claiming the benefit of priority from Japanese Patent Application No. 2022-194255 filed on Dec. 5, 2022, the disclosure of which is incorporated in its entirety herein by reference.

### TECHNICAL FIELD

The present disclosure relates to electromagnetic relay devices.

### BACKGROUND

One of known electromagnetic relay devices, which is disclosed in Japanese Patent Application Publication No. 2010-010058, is configured to cause a movable member having at least one movable contact to reciprocate based on electromagnetic attractive force generated by an energized electromagnetic coil. This causes the at least one movable contact to abut onto at least one stationary contact or separate therefrom. The yoke of the electromagnetic relay device disclosed in the patent publication located in front of the electromagnetic coil is configured as a separate member from a stationary core located inside of the electromagnetic coil. The yoke is crimped to the stationary core.

The arrangement of the magnetic assembly, which is comprised of the stationary core and the yoke of the electromagnetic relay device disclosed in the patent publication, and the electromagnetic coil results in a clearance therebetween. This clearance enables other components to be easily arranged therein and the magnetic assembly and the electromagnetic coil to be easily assembled to each other.

### SUMMARY

At the joint portion of the yoke and the stationary core, the rear surface of the yoke and the outer peripheral surface of the stationary core of the electromagnetic relay device disclosed in the patent publication are arranged to intersect orthogonally. This may result in the distance between the joint portion and the wire winding portion of the electromagnetic coil being likely to be increased. There is potential to improve the electromagnetic relay device disclosed in the patent publication in view of magnetic efficiency.

The present disclosure seeks to provide electromagnetic relay devices, each of which is capable of improving magnetic efficiency.

An exemplary aspect of the present disclosure provides an electromagnetic relay device. The electromagnetic relay device includes a movable member including a movable contact movable to abut onto and separate from a stationary contact. The electromagnetic relay device includes a plunger configured to cause the movable member to reciprocate to accordingly cause the movable contact to abut onto or separate from the stationary contact. The electromagnetic relay device includes a solenoid unit configured to cause the plunger to reciprocate in a predetermined reciprocation direction. The solenoid unit includes an electromagnetic coil that includes a winding portion comprised of a wound conductive wire, the winding portion being configured to generate magnetic flux when energized. The solenoid unit includes a stationary core that includes a through hole through which the plunger is arranged to pass and that is located inside the magnetic coil. The solenoid unit includes a movable core arranged behind the stationary core and fixed to the plunger. The stationary core and the movable core constitute a magnetic path of the magnetic flux generated by the energized winding portion. The movable core is configured to reciprocate with respect to the stationary core when the winding portion is energized. The stationary core includes a plate member located in front of the electromagnetic coil. The plate member has a rear-side surface and being arranged to overlap the electromagnetic coil when viewed in the reciprocation direction. The stationary core has a stationary inside portion located inside the electromagnetic coil. The stationary inside portion has an outer peripheral surface. The plate member and the stationary inside portion are integrated with each other. The electromagnetic coil and the stationary core are arranged to form a clearance therebetween. The stationary core has a joint surface between the outer peripheral surface of the stationary inside portion and the rear-side surface of the plate member. The joint surface is curved convexly with respect to the plunger to constitute a stationary curved surface

The electromagnetic relay device is configured such that (i) the plate member and the stationary inside portion are integrated with each other and (ii) the stationary curved surface is formed between the outer peripheral surface of the stationary inside portion and the rear-side surface of the plate member. This configuration of the electromagnetic relay device enables a joint portion between the stationary inside portion and the plate member to be closer to the winding portion of the electromagnetic coil. This therefore makes it possible to improve the magnetic efficiency of the electromagnetic relay device.

The exemplary aspect of the present disclosure provides the electromagnetic relay device, which has an improved magnetic efficiency.

Note that each parenthesized reference character assigned to a corresponding element in claims described later represents a relationship between the corresponding element and a corresponding specific measure described in the following embodiments described later, and therefore the parenthesized reference characters used in the claims should not be interpreted implying limitation.

### BRIEF DESCRIPTION OF THE DRAWINGS

Other aspects of the present disclosure will become apparent from the following description of an embodiment with reference to the accompanying drawings in which:

FIG. 1 is an axial cross-sectional view of an electromagnetic relay device according to the first embodiment with movable contacts being respectively separated from corresponding stationary contacts;

FIG. 2 is an axial cross-sectional view of the electromagnetic relay device according to the first embodiment with the movable contacts respectively abutting onto the corresponding stationary contacts;

FIG. 3 is an enlarged axial cross-sectional view of a portion of the electromagnetic relay device according to the first embodiment, the portion being located around a stationary curved surface of the electromagnetic relay device of the first embodiment;

FIG. 4 is an axial cross-sectional view illustrating magnetic flux passing through a magnetic path according to the first embodiment;

FIG. 5 is an axial cross-sectional view illustrating how a metallic member is inserted into a recess according to the first embodiment;

FIG. 6 is an axial cross-sectional view illustrating how the metallic member is plastically deformed using a press jig according to the first embodiment;

FIG. 7 is an axial cross-sectional view illustrating the metallic member formed with a plate-like portion according to the first embodiment;

FIG. 8 is a plan view illustrating the metallic member formed with a plate-like portion when viewed in an axial direction of the metallic member;

FIG. 9 is a plan view illustrating the metallic member with the plate-like portion, a part of which has been punched out according to the first embodiment;

FIG. 10 is an axial cross-sectional view of an electromagnetic relay device according to a comparison example 1 with movable contacts being respectively separated from corresponding stationary contacts;

FIG. 11 is an enlarged axial cross-sectional view of a portion of the electromagnetic relay device according to the comparison example 1, the portion being located around a joint portion between a stationary core and a plate member of the electromagnetic relay device of the comparison example 1;

FIG. 12 is an enlarged axial cross-sectional view of a portion of an electromagnetic relay device according to the second embodiment, the portion being located around a stationary curved surface of the electromagnetic relay device of the second embodiment;

FIG. 13 is an enlarged axial cross-sectional view of a portion of an electromagnetic relay device according to the third embodiment, the portion being located around a stationary curved surface of the electromagnetic relay device of the third embodiment; and

FIG. 14 is an enlarged axial cross-sectional view of a portion of an electromagnetic relay device according to the fourth embodiment, the portion being located around a stationary curved surface of the electromagnetic relay device of the fourth embodiment.

### DETAILED DESCRIPTION OF EMBODIMENTS

### First embodiment

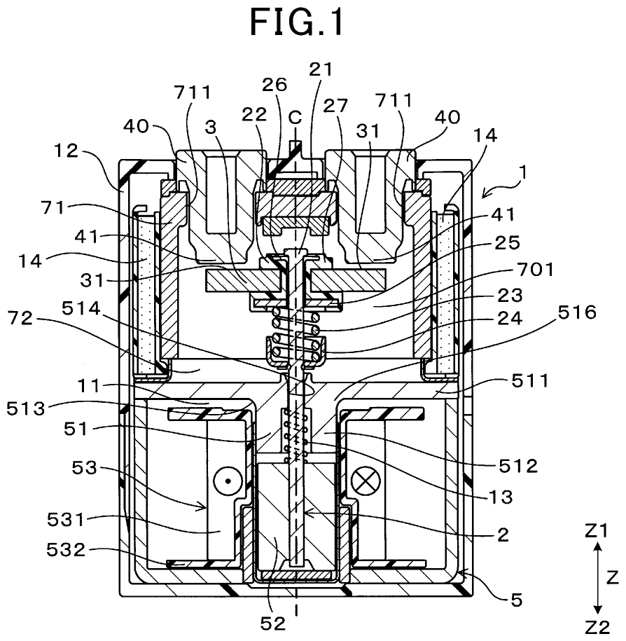

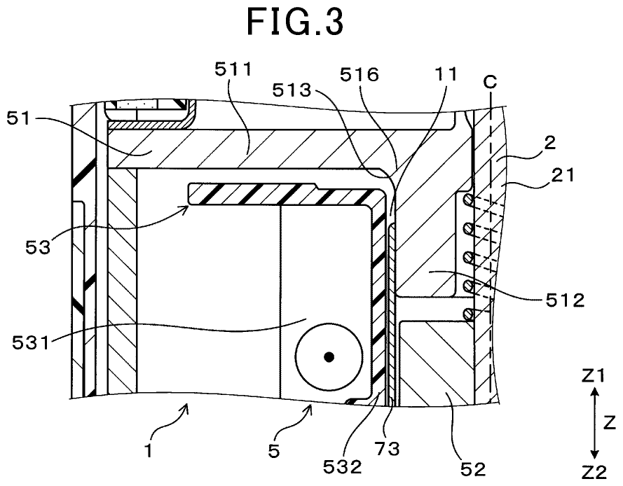

The following describes an electromagnetic relay device 1 according to the first embodiment with reference to FIGS. 1 to 9.

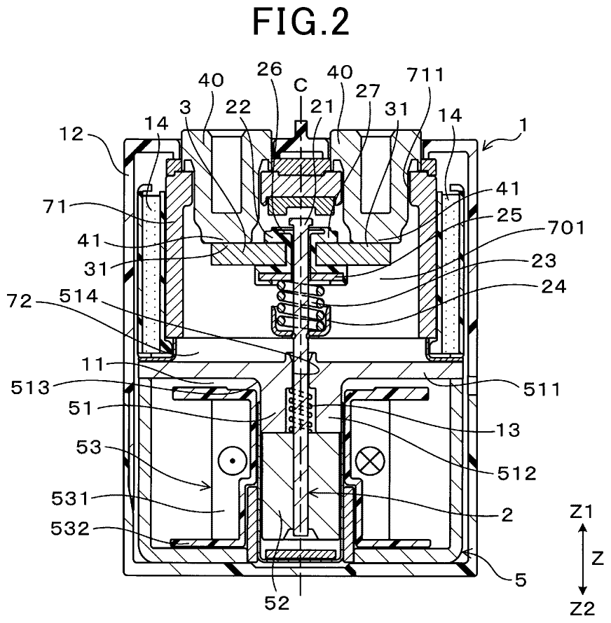

Referring to FIGS. 1 and 2, the electromagnetic relay device 1 includes a plunger 2, a movable member 3, and a solenoid unit 5. The movable member 3 includes movable contacts 31 that are movable to abut onto and separate from the respective stationary contacts 41. That is, the reciprocation of the plunger 2 causes the movable member 3 to reciprocate to accordingly cause the movable contacts 31 to abut onto or separate from the respective stationary contacts 41. The solenoid unit 5 causes the plunger 2 to reciprocate. That is, the reciprocation of the plunger 2 causes the movable member 3 to reciprocate to accordingly cause the movable contacts 31 to abut onto or separate from the respective stationary contacts 41.

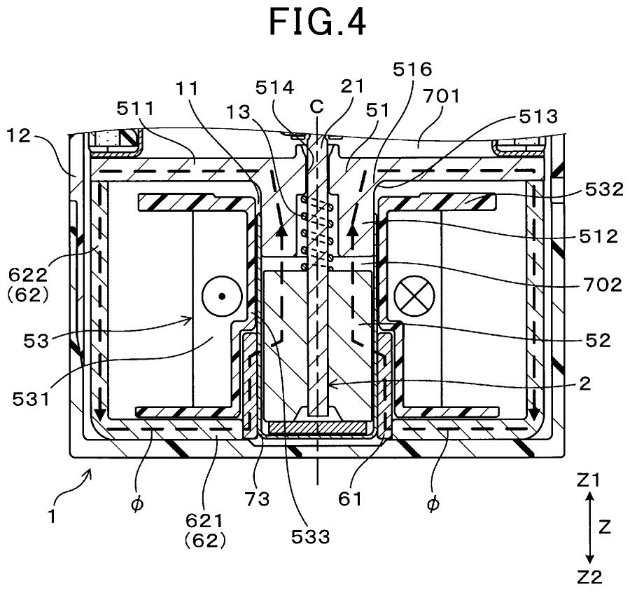

The solenoid unit 5 includes a stationary core 51, a movable core 52, and an electromagnetic coil 53. The electromagnetic coil 53 includes a winding portion 531 comprised of a wound conductive wire. The electromagnetic coil 53 is configured to generate magnetic flux ϕ when the winding portion 531 is energized (see FIG. 4).

The stationary core 51 has a through hole 514 through which the plunger 2 is arranged to pass. The stationary core 51 has a portion 512 located inside the electromagnetic coil 53. The movable core 52 is located behind (see reference character Z2) the stationary core 51 and fixed to the plunger 2. The stationary core 51 and the movable core 52 constitute a magnetic path of the magnetic flux ϕ generated by the energized winding portion 531. The movable core 52 is configured to reciprocate with respect to the stationary core 51 when the winding portion 531 is energized.

The stationary core 51 includes a plate member 511. The plate member 511 is located in front of the electromagnetic coil 53 and is arranged to overlap the electromagnetic coil 53 when viewed in the reciprocation direction (see reference character Z) of the plunger 2. The plate member 511 and the portion 512 of the stationary core 51, which is located inside the electromagnetic coil 53, are integrated with each other. The portion 512 of the stationary core 51 will be referred to as a stationary inside portion 512.

The electromagnetic coil 53 and the stationary core 51 are arranged to form a clearance 11 therebetween. The stationary core 51 has a joint surface 513 between the outer peripheral surface of the stationary inside portion 512 and the rear-side surface of the plate member 511. The joint surface 513 is curved convexly with respect to the plunger 2 to constitute as a stationary curved surface 513.

As described above, the reciprocation direction Z of the plunger 2 has the opposing front side Z1 and rear side Z2. The front side Z1 of the reciprocation direction Z is defined as the direction in which the movable core 52 approaches the stationary core 51, and the rear side Z2 of the reciprocation direction Z is opposite to the first side Z1. The winding portion 531 has a center axis C around which the conductive wire is wound. Radial directions are defined as radial directions of any circle centered on the center axis C when viewed in the reciprocation direction Z of the plunger 2. A circumferential direction is defined as a direction along the circumferential direction of any circle centered on the center axis C. The winding portion 531 according to the first embodiment is arranged such that the center axis C thereof extends along the reciprocation direction Z of the plunger 2.

The electromagnetic relay device 1 can be used, for example, as a system main relay for electric vehicles or hybrid vehicles or a main relay for quick charging. When the electromagnetic relay device 1 is used as a system main relay or a quick-charging main relay, the electromagnetic relay device 1 can be used, for example, as a high-capacity relay rated at 400 A or less, or as a relay compatible with 800 V.

Referring to FIG. 1, the electromagnetic relay device 1 includes an enclosure housing 12 that encloses the movable member 3, the plunger 2, and the solenoid unit 5 therein. The enclosure housing 12 is made of, for example, an insulating material, such as resin.

The electromagnetic relay device 1 of the first embodiment includes a tubular cylindrical sealing housing 71 located inside the enclosure housing 12. The tubular rear end of the sealing housing 71 is fixed to the outer peripheral edge of the plate member 511. The movable contacts 31 and the stationary contacts 41 are arranged in a chamber 701 surrounded by the sealing housing 71 and the plate member 511. The chamber 701 will also be referred to as a contact arrangement chamber 701.

The sealing housing 71 is made of, for example, ceramic.

The tubular rear end of the sealing housing 71 and the plate member 511 are fixed while being sealed together along the entire circumference of the tubular read end via an interposed member 72 made of, for example, iron. Welding the interposed member 72 and the plate member 511 to one another and brazing the interposed member 72 and the sealing housing 71 to one another result in the sealing housing 71 and the plate member 511 being fixed to one another while being sealed together via the interposed member 72.

Two terminals 40 are fixed to the sealing housing 71 while being electrically isolated from one another. Specifically, the front end of the sealing housing 71 has through holes 711 formed therethrough, and each of the fixed terminals 40 is fit in the corresponding one of the through holes 711 while a part of each of the fixed terminals 40 is located inside the tubular sealing housing 71. Each fixed terminal 40 is brazed to the sealing housing 71 so that the space between the corresponding fixed terminal 40 and the sealing housing 71 is hermetically sealed. The front end of the enclosure housing 12 has through holes formed therethrough, and each fixed terminal 40 is additionally fit in the corresponding one of the through holes of the front end of the enclosure housing 12. Each of the fixed terminals 40 is formed with the corresponding one of the two stationary contacts 41 at the rear end thereof. The two stationary contacts 41 are directed toward the rear side Z2 of the reciprocation direction Z. Each fixed terminal 40 is made of, for example, a conductive material, such as copper.

The two movable contacts 31 are arranged to be opposed to the respective two stationary contacts 41 in the reciprocation direction Z. The movable member 3 is formed with the corresponding one of the two movable contacts 31 located on the front side thereof. The movable member 3 is comprised of, for example, a metal plate.

The plunger 2 includes a shaft 21. The movable member 3 has a portion located between the two movable contacts 3. The shaft 21 of the plunger 2 is located to pass through the portion of the movable member 3.

The movable member 3 is mounted to the shaft 21 through a holder 22. The holder 22 is comprised of a base 27 made of resin, a tubular cylindrical shaft support member 26, and a movable yoke 25. The shaft support member 26 is arranged to surround the outer periphery of a part of the shaft 21. The movable yoke 25 is arranged around the movable core 3. The base 27, the movable core 3, the shaft support member 26, and the movable yoke 25 are integrally molded using insert molding. The shaft 21 and the holder 22 are configured to be slidable together in the reciprocation direction Z. A contact pressure spring 23 is provided behind the holder 22 around the shaft 21. The contact spring 23 is configured to elastically support the holder 22 in the reciprocation direction Z. The contact pressure spring 23 has opposing front and rear ends. The rear end of the contact pressure spring 23 abuts onto a support member 24 secured to the shaft 21, and the front end of the contact pressure spring 23 abuts onto a rear surface of the movable yoke 25.

The shaft 21 is located to slidably pass through the through hole 514 formed through the stationary core 51. The shat 21 of the first embodiment is made of non-magnetic metal, and is configured as a rod-shaped member. The shaft 21 is arranged with its longitudinal direction aligning with the reciprocation direction Z. The center axis C of the winding portion 531 corresponds to the center axis of the shaft 21.

The electromagnetic coil 53 is, as illustrated in FIG. 4, arranged at the rear side Z2 of the plate member 511. The electromagnetic coil 53 has an insulating bobbin 532 that has a tubular cylindrical portion 533. Winding a conductive wire around the outer periphery of the tubular cylindrical portion 533 of the bobbin 532 forms the winding portion 531. The tubular cylindrical portion 533 is configured to be open in both sides of the reciprocation direction Z.

The bobbin 532 is arranged to be spaced apart from the stationary curved surface 513 of the stationary core 53. That is, the electromagnetic coil 53 is arranged to be spaced apart from the stationary curved surface 513 of the stationary core 53. The electromagnetic coil 53 and the stationary curved surface 513 of the stationary core 51 are arranged to form the clearance 11 therebetween. The clearance 11 is also formed to radially extend between the stationary inside portion 512 and the electromagnetic coil 53, and formed between the plate member 511 and the electromagnetic coil 53 in the reciprocation direction Z.

The stationary inside portion 512 of the stationary core 51 and the movable core 52 are arranged inside the tubular cylindrical portion 533 of the electromagnetic coil 53. A return spring 13, which is comprised of a coil spring, is arranged in an elastically compressed state between the stationary core 51 and the movable core 52 in the reciprocation direction Z. That is, the return spring 13 is configured to bias the movable core 52 in the direction away from the stationary contacts 41 for moving the movable contacts 31.

A sleeve 73 is directly or indirectly fixed to the stationary core 51 to hermetically seal the return spring 13 and the movable core 52. The sleeve 73 has a bottomed tubular cylindrical shape, and the inner periphery of the sleeve 73 is directly joined to the outer peripheral surface of the stationary inside portion 512 of the stationary core 51 according to the first embodiment. The outer peripheral surface of the stationary inside portion 512 extends in parallel to the reciprocation direction Z. The sleeve 73 is made of, for example, stainless steel. No particular limitation is imposed on the material of stainless steel.

The sleeve 73, which has the bottomed tubular cylindrical shape, is arranged to cover the rear end surface and the outer peripheral surface of the movable core 52. The sleeve 73 has a tubular front end, and the tubular front end of the sleeve 73 is located in the clearance 11 formed between the electromagnetic coil 53 and the stationary inside portion 512. The front end of the sleeve 73 is arranged to be separated from the plate member 511. The tubular front end of the sleeve 73 is located at the rear side Z2 of the stationary curved surface 513 of the stationary core 51. The inner peripheral surface of the tubular front end of the sleeve 73 is fixed to the stationary inside portion 512. The tubular front end of the sleeve 73 is arranged to face the stationary curved surface 513.

The inner peripheral surface of the sleeve 73 and the outer peripheral surface of the stationary inside portion 512 are sealed to one another along the entire circumference of the inner peripheral surface of the sleeve 73. For example, the inner peripheral surface of the sleeve 73 and the outer peripheral surface of the stationary inside portion 512 are welded to one another along the entire circumference of the inner peripheral surface of the sleeve 73.

The above arrangement of the sleeve 73 and the stationary core 51 results in a space, which will be referred to as a core arrangement space 702, being defined between the sleeve 73 and the stationary core 51, and the movable core 52 and the return spring 13 are disposed in the core arrangement space 702 while being substantially hermetically sealed therein. That is, there is a small clearance between the inner peripheral surface of the through hole 514 of the stationary core 51 and the outer peripheral surface of the shaft 21. The small clearance enables the core arrangement space 702 and the contact arrangement chamber 701 to communicate with one another therethrough. The core arrangement space 702 and the contact arrangement chamber 701 are hermetically sealed from the outside, so that the contact arrangement chamber 701 is hermetically sealed against the external environment. Gas, such as hydrogen gas or nitrogen gas, is filled in the contact arrangement chamber 701.

The solenoid unit 5 of the first embodiment includes first and second yokes 61 and 62 disposed around the electromagnetic coil 53. Energizing the winding portion 531 of the electromagnetic coil 53 causes the magnetic flux ϕ to flow through the magnetic path constituted by the stationary core 51, the movable core 52, and the first and second yokes 61 and 62, resulting in the stationary core 51 and the movable core 52 being magnetized. The magnetization of the stationary core 51 and the movable core 52 generates magnetic attractive force between the stationary core 51 and the movable core 52.

The first yoke 61 has a tubular cylindrical shape, and is radially located between the rear-side portion of the electromagnetic coil 53 and the movable core 52. The second yoke 62 is comprised of a rear-side portion 621 and an outer peripheral portion 622. The rear-side portion 621 of the second yoke 62 is arranged to cover the electromagnetic coil 53 from the rear side Z2 of the electromagnetic coil 53. The outer peripheral portion 622 of the second yoke 62 is arranged to cover the electromagnetic coil 53 from the radial sides of the electromagnetic coil 53. The outer peripheral portion 622 has a tubular cylindrical shape, and is arranged to extend from the outer peripheral edge of the rear-side portion 621 toward the front side Z1.

The stationary inside portion 512 of the stationary core 51 is arranged such that the outer peripheral surface of the stationary inside portion 512 is located to follow the inner peripheral surface of the tubular cylindrical portion 533 of the bobbin 532. The stationary inside portion 512 of the stationary core 51 is arranged to face the movable core 52 in the reciprocation direction Z. Each of the stationary core 51 and the movable core 52 is made of soft magnetic metal.

The plate member 511 of the stationary core 51 has a plate-like shape that expands radially outward from the front end of the stationary inside portion 512. The plate member 511 is arranged to cover the front portion of the electromagnetic coil 53. The plate member 511 is arranged to overlap the whole of the electromagnetic coil 53 when viewed in the reciprocation direction Z. The plate member 511 is located in front of the center of the stationary core 51.

The plate member 511 is formed around the stationary inside portion 512 over the entire circumferential direction when viewed in the reciprocation direction. The radially outer end of the plate member 511 is located radially outside the electromagnetic coil 53. The radially outer end of the plate member 511 is arranged to abut onto the front end of the outer peripheral portion 622 of the second yoke 62.

The stationary curved surface 513 is formed to extend circumferentially over the entire circumferential direction. The stationary curved surface 513 is located radially inside the winding portion 531, and also located in front of winding portion 531. The stationary curved surface 513 is additionally located radially inside the outer peripheral surface of the first yoke 61. The stationary curved surface 513 is located in front of the front end of the sleeve 73, and also located in front of the center of the stationary core 51.

The shaft 12 is fixed to the movable core 52 while arranged to pass through the through hole formed through the movable core 52. This enables the movable core 52 and the shaft 21 to move together.

Next, the following describes how the electromagnetic relay device 1 according to the first embodiment operates with reference to FIGS. 1 and 2.

When the electromagnetic coil 53 is in a non-energized state, no magnetic attractive force appears between the stationary core 51 and the movable core 52. For this reason, as illustrated in FIG. 1, the movable core 52 has moved in the direction away from the stationary core 51, i.e., the rearward direction by the biasing force of the return spring 13. That is, the movable member 3, which is mounted to the movable core 52 via the shaft 21 and the holder 22, is in a rearward retracted state, so that the two movable contacts 31 are separated from the two stationary contacts 41.

When the electromagnetic coil 53 is in the non-energized state, energization of the electromagnetic coil 53 generates magnetic attractive force between the movable core 51 and the stationary core 52. The generated magnetic attractive force causes, as illustrated in FIG. 2, the movable core 52 to move in the forward direction against the biasing force, i.e., returning force, of the return spring 13, so that the shaft 21 and the movable member 3 move in the forward direction. This results in the two movable contacts 31 abutting onto the respective two stationary contacts 41, so that the electromagnetic relay device 1 is in a closed state, i.e., a switch-on state. This enables a current to flow from one of the fixed terminals 40 to the other thereof through the movable member 3.

In particular, the movable core 52 according to the first embodiment moves until the front end of the movable core 52 abuts onto the rear end of the stationary core 51. That is, the movable core 52 continues to further move in the forward direction even after the movable contacts 31 have abutted onto the respective stationary contacts 41. During the further movement of the movable core 52, although the shaft 21 fixed to the movable core 52 similarly moves in the forward direction, the movable member 3 does not move because the movable contacts 31 have abutted onto the respective stationary contacts 41. For this reason, the shaft 21 moves in the forward direction relative to the movable member 3, resulting in the contact pressure spring 23 being compressed and deformed. The elastic force by the compressed contact pressure spring 23 contributes to the contact pressure between the stationary contacts 41 and the respective movable contacts 31.

When the electromagnetic coil 53 is in the energized state illustrated in FIG. 2, de-energization of the electromagnetic coil 53 causes the magnetic attractive force between the movable core 51 and the stationary core 52 to disappear. The returning force of the return spring 13 causes the movable core 52 to move in the rearward direction, so that the movable contacts 31 are separated from the respective stationary contacts 41 (see FIG. 1). This results in the electromagnetic relay device 1 being in an open state, i.e., a switch-off state.

The electromagnetic relay device 1 is changed from the closed state to the open state only after an electrical arc generated between the movable contact 31 and the stationary contact 41 of any pair disappears.

For addressing the arc-related problem, the electromagnetic relay device 1 of the first embodiment includes an arc-extinguishing magnet 14 for stretching and extinguishing the electrical arc generated between the movable contact 31 and the stationary contact 41 of any pair. The arc-extinguishing magnet 14 is located radially outside the pars of the movable contacts 31 and the stationary contacts 41. The arc-extinguishing magnet 14 of the electromagnetic relay device 1 is configured to stretch the electrical arc generated between the movable contact 31 and the stationary contact 41 of any pair in a direction orthogonal to the reciprocation direction Z to thereby extinguish the electrical arc.

Next, the following describes a method of manufacturing the stationary core 51 with reference to FIGS. 5 to 9.

As illustrated in FIG. 5, processing a metallic member 510, which is made of soft-magnetic metal and has a substantially cylindrical shape, fabricates the stationary core 51.

First, forging of the metallic member 510 is carried out using a holding fixture 191 that has a cylindrical recess 192 formed in a front major surface of the holding fixture 191; the recess 192 has a bottom 194. Along the entire boundary between the inner peripheral surface of the cylindrical recess 192 and the front major surface of the holding fixture 191, an opening curved surface 193 conforming to the stationary curved surface 513 is formed.

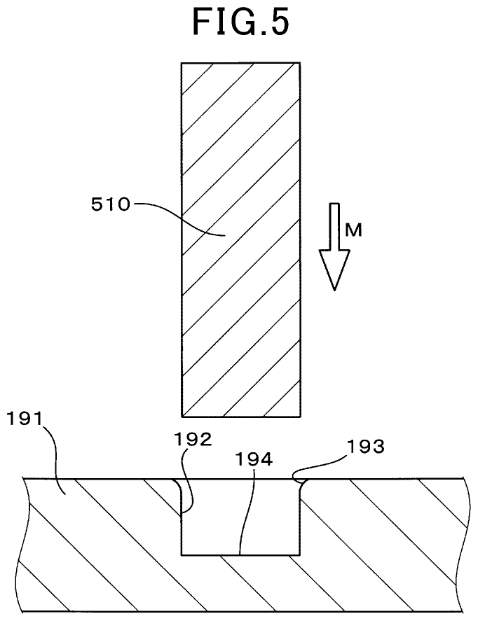

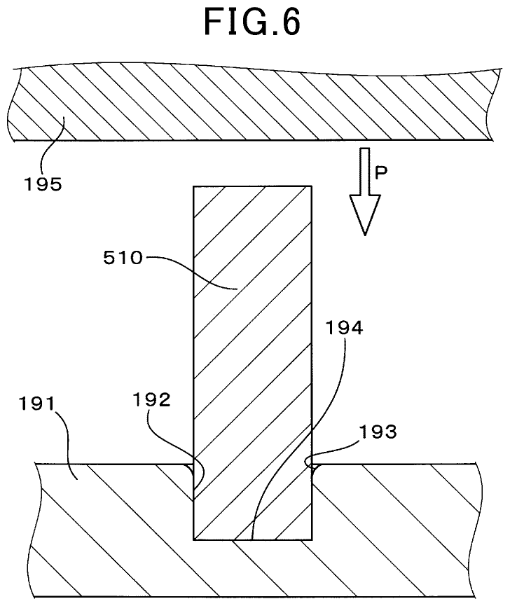

As illustrated by the arrow M illustrated in FIG. 5, the metallic member 510, which has opposing front and rear end surfaces, is inserted into the cylindrical recess 192 through the opening curved surface 193. Specifically, as illustrated in FIG. 6, the inserting step inserts the metallic member 510 into the recess 192 such that the rear end surface of the metallic member 510 abuts onto the bottom 194 of the recess 192 while a portion of the metallic member 510, which exceeds half the axial length of the metallic member 510 is exposed outside the recess 192. Because the inner radius of the recess 192 substantially matches the outer radius of the metallic member 510, when the metallic member 510 has completely inserted in the recess 192, the inner peripheral surface of the recess 192 abuts onto the outer peripheral surface of the metallic member 510. When the metallic member 510 has completely inserted in the recess 192, the opening curved surface 193 is tapered toward the rear end surface of the metallic member 510.

Next, forging of the metallic member 510 mounted in the recess 192 of the holding fixture 191 is carried out using a press jig 195.

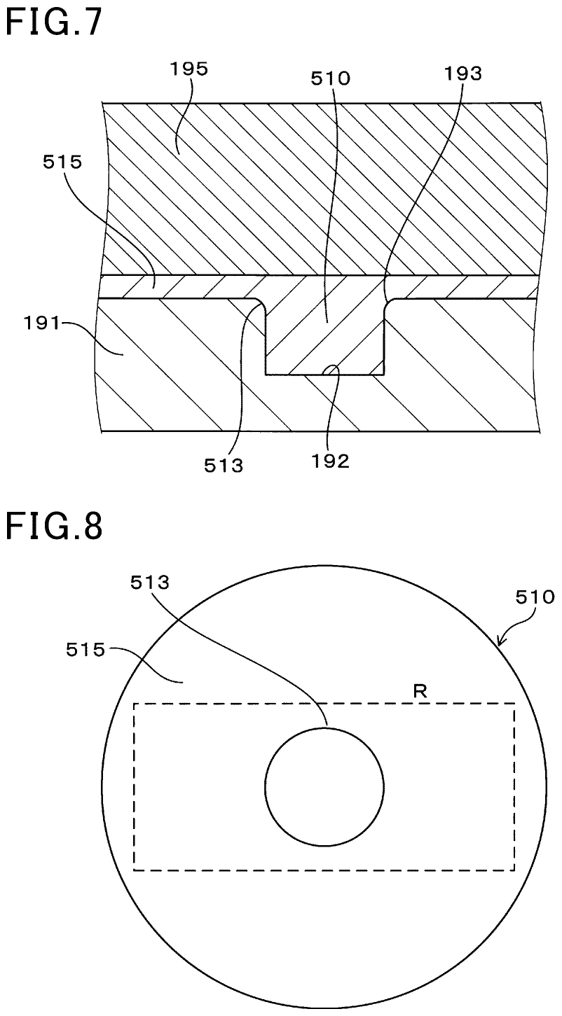

Specifically, as illustrated by the arrow P illustrated in FIG. 6, pressing the press jig 195 onto the metallic member 510 from the front end side, which is opposite to the rear end side thereof causes plastic deformation of the metallic member 510. Specifically, the metallic member 510 is plastically deformed so that the exposed portion of the metallic member 519, which is located outside the recess 192, is deformed into a flat-plate shape, so that, as illustrated in FIG. 7, a plate-like portion 515 is formed; the plate-like portion 515 becomes the plate member 511.

During the pressing process using the press jig 195, a portion of the metallic member 510, which abuts onto the opening curved surface 193 of the holding fixture 191, is plastically deformed along the opening curved surface 193, so that the stationary curved surface 513 is formed on the metallic member 510. That is, a portion of the metallic member 510, which is arranged in the recess 192, becomes the stationary inside portion 512.

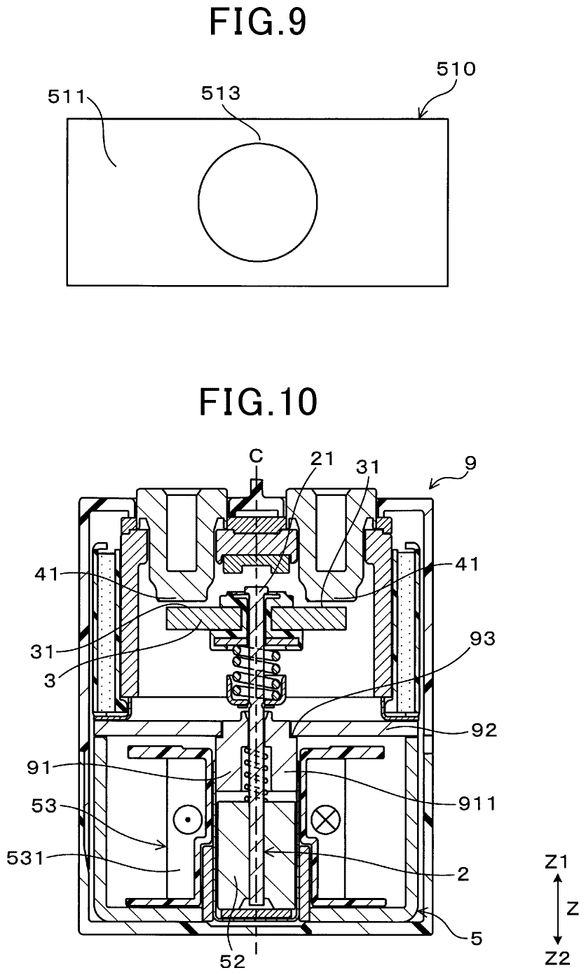

The plate-like portion 515 formed by the forging process has, as illustrated in FIG. 8, a disk-like shape. The plate member 511 of the first embodiment has a substantially rectangular shape when viewed in the reciprocation direction Z. For this reason, punching out a portion within a predetermined range R, enclosed by a dashed line in FIG. 8, from the plate member 511 results in the plate member 511 being formed (see FIG. 9). Although a detailed description is omitted, after the plate member 511 is formed, forming, for example, the through hole 514 through the metallic member 510 results in the stationary core 51 of the first embodiment being fabricated.

Next, the following describes advantageous effects of the electromagnetic relay device 1 according to the first embodiment.

The electromagnetic relay device 1 according to the first embodiment set forth above is configured such that (i) the plate member 511 and the stationary inside portion 512 are integrated with each other and (ii) the stationary curved surface 513 is formed between the outer peripheral surface of the stationary inside portion 512 and the rear-side surface of the plate member 511. This configuration of the electromagnetic relay device 1 enables a joint portion 516 between the stationary inside portion 512 and the plate member 511 to be closer to the winding portion 531 of the electromagnetic coil 53. This therefore makes it possible to improve the magnetic efficiency of the electromagnetic relay device 1.

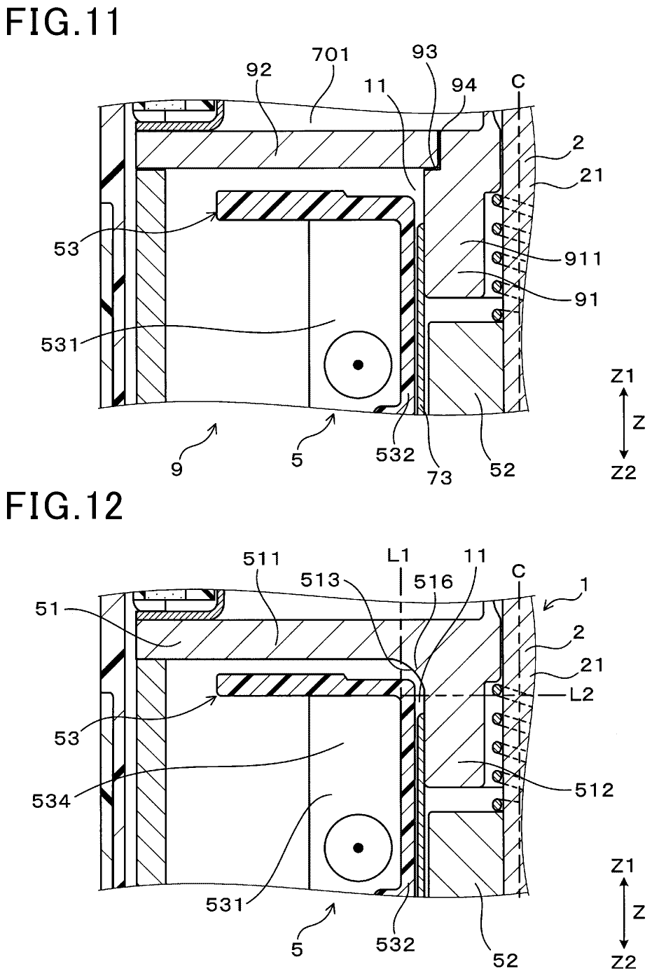

Let us assume an electromagnetic relay device 9 according to comparison example 1. The electromagnetic relay device 9 according to the comparison example 1 includes, as illustrated in FIGS. 11 and 12, a stationary core 91 and a plate member 92 configured as separation members from one another, and no curved surface is formed between the outer peripheral surface of a stationary inside portion 911 of the stationary core 91 and the rear-side surface of the plate member 92.

The electromagnetic relay device 9 according to the comparison example 1 is configured such that stationary core 91 including the plate member 92 crimped to the stationary inside portion 911. In the electromagnetic relay device 9 of the comparison example 1, the rear end surface of the plate member 92 and the outer peripheral surface of the stationary core 91 at the joint portion 93 between the stationary core 91 and the plate member 92 are orthogonal to each other.

As compared with the electromagnetic relay device 1 of the first embodiment, which includes the stationary curved surface 513, the distance between the joint portion 93 and the winding portion 531 of the electromagnetic relay device 9 may be longer than the distance between the joint portion 516 and the winding portion 531 of the electromagnetic relay device 1 of the first embodiment.

Specifically, in consideration of (i) the ease of assembly of the stationary core 91 and the electromagnetic coil 53 and (ii) arrangement of one or more components, such as the sleeve 73, between the stationary core 91 and the electromagnetic coil 53, it is necessary to ensure a clearance 11 between the electromagnetic coil 53 and the stationary core 91 and between the electromagnetic coil 53 and the plate member 92. For this reason, if the electromagnetic relay device 9 of the comparison example 1 is configured such that the clearance 11 is ensured and the outer peripheral surface of the stationary core 91 and the rear end surface of the plate member 92 are orthogonal to each other, the distance between the joint portion 93 and the winding portion 531 of the electromagnetic relay device 9 may be likely to be increased. This therefore may result in the magnetic efficiency of the electromagnetic relay device 9 being likely to be low.

In contrast, the electromagnetic relay device 1 of the first embodiment is configured such that (i) the plate member 511 and the stationary inside portion 512 are integrated with each other and (ii) the stationary curved surface 513 is formed on the joint portion 516 between the stationary inside portion 512 and the stationary inside portion 512.

This configuration of the electromagnetic relay device 1 enables the joint portion 516 between the stationary inside portion 512 and the plate member 511 to be closer to the winding portion 531 of the electromagnetic coil 53 as compared with the electromagnetic relay device 9 of the comparison example 1. That is, the stationary curved surface 513 formed on the joint portion 516 between the stationary inside portion 512 and the stationary inside portion 512 is less likely to influence on (i) the ease of assembly of the stationary core 91 and the electromagnetic coil 53 and (ii) arrangement of one or more components, such as the sleeve 73, between the stationary core 91 and the electromagnetic coil 53. This therefore makes it possible to improve the magnetic efficiency of the electromagnetic relay device 1 while ensuring the ease of assembly of the stationary core 91 and the electromagnetic coil 53. The improvement of the magnetic efficiency of the electromagnetic relay device 1 enables the number of turns of the conductive wire, which constitutes the winding portion 531, to be smaller. This therefore makes it possible to downsize the electromagnetic coil 53 to accordingly downsize the electromagnetic relay device 1.

The stationary core 91 and the plate member 92 of for example the comparison example 1, which are configured as separation members from one another, may result in a curved surface being less likely to be formed on the connection portion 93. That is, in a case of trying to form such a curved surface on the connection portion 93, the shape of at least one of the stationary core 91 and the plate member 92 may be likely to be complicated, resulting in the manufacturability of the electromagnetic relay device 9 being likely to deteriorate.

In contrast, the electromagnetic relay device 1 of the first embodiment, which is configured such that (i) the plate member 511 and the stationary inside portion 512 are integrated with each other, makes it easier to form the stationary curved surface 513 on the integrated stationary inside portion 512 and stationary inside portion 512 as compared with a case where the integrated stationary inside portion and stationary inside portion are configured as separation members. This therefore results in an improvement of both (i) the magnetic efficiency and (ii) the manufacturability of the electromagnetic relay device 1.

Like the electromagnetic relay device 9 of the comparison example 1, if the plate member 92 is fixedly crimped to the stationary core 92 (see FIG. 11), a gap 94 may be formed between the plate member 92 and the stationary core 91. The existence of the gap 94 in the magnetic path constituted through the stationary core 92 may result in the magnetic efficiency being likely to deteriorate.

In contrast, the electromagnetic relay device 1 of the first embodiment, which is configured such that (i) the plate member 511 and the stationary inside portion 512 are integrated with each other, results in no gap therebetween, resulting in the magnetic efficiency of the electromagnetic relay device 1 being higher.

The electromagnetic relay device 1 of the first embodiment, which is configured such that the stationary curved surface 513 is formed between the outer peripheral surface of the stationary inside portion 512 and the rear-side surface of the plate member 511, results in the area of the connection portion 516 in a cross-section, which contains the center axis C, on the stationary curved surface 513 being likely to become larger as compared with the electromagnetic relay device 9 of the comparison example 1. This results in the magnetic path of the electromagnetic relay device 1 of the first embodiment being likely to become wider as compared with the electromagnetic relay device 9 of the comparison example 1, making it possible to further improve the magnetic efficiency of the electromagnetic relay device 1.

The stationary core 51 according to the first embodiment can be manufactured using forging and pressing. This makes it easier to manufacture the stationary core 51, resulting in the manufacturability of the electromagnetic relay device 1 being higher.

The electromagnetic relay device 1 of the first embodiment, which is configured such that the plate member 511 and the stationary inside portion 512 are integrated with each other, results in air-tightness of the contact arrangement chamber 701 being more reliably ensured.

Specifically, like the comparison example 1, the gap 94 formed between the plate member 92 and the stationary core 91 may cause gas to leak from the contact arrangement chamber 701 into a space in which the electromagnetic coil 53 is located therethrough, resulting in the air-tightness of the contact arrangement chamber 701 deteriorating. In addition, if the method of manufacturing the electromagnetic relay device 9 with the gap 94 additionally performs a step of closing the gap 94, the manufacturability of the electromagnetic relay device 9 may be deteriorated.

In contrast, the electromagnetic relay device 1 of the first embodiment, which is configured such that the plate member 511 and the stationary inside portion 512 are integrated with each other, reliably prevents gas from leaking from the contact arrangement chamber 701 into a space in which the electromagnetic coil 53 is located. This results in air-tightness of the contact arrangement chamber 701 being more reliably ensured while improving the manufacturability of the electromagnetic relay device 1.

Additionally, the electromagnetic coil 53 and the stationary curved surface 513 of the stationary core 51 are arranged to form the clearance 11 therebetween. This enables the electromagnetic coil 53 and the stationary core 51 to be reliably assembled to each other even if each of the electromagnetic coil 53 and the stationary core 51 has dimensional variation, thus ensuring the ease of assembly of the electromagnetic coil 53 and the stationary core 51. The clearance 11 formed to radially extend between the stationary inside portion 512 and the electromagnetic coil 53 enables the sleeve 73 to be more easily arranged between the stationary inside portion 512 and the electromagnetic coil 53, resulting in the core arrangement chamber 702 being more easily formed.

As described in detail above, the present disclosure provides the electromagnetic relay device 1 according to the first embodiment, which has an improved magnetic efficiency.

### Second embodiment

As compared with the electromagnetic relay device 1 of the first embodiment, the area of the stationary curved surface 513 formed on the joint portion 516 according to the second embodiment is, as illustrated in FIG. 12, greater than that of the first embodiment.

As illustrated in FIG. 12, a first virtual linear line L1 and a second virtual linear line L2 are defined in the second embodiment. The first virtual linear line L1 is defined as a linear line on a cross-section that contains the center axis C of the winding portion 531; the first virtual linear line L1 passes through the inner peripheral edge of the winding portion 531 in parallel to the reciprocation direction Z. The second virtual linear line L2 is defined as a linear line on the cross-section, and the second virtual linear line passes through the front end of the winding portion 531 in orthogonal to the reciprocation direction Z.

In the electromagnetic relay device 1 of the second embodiment, at least one of the first and second virtual linear lines L1 and L2 passes through the stationary curved surface 513 on the cross-section that contains the center axis C of the winding portion 531.

FIG. 12 illustrates an example where the first virtual linear line L1 passes through the stationary curved surface 513 without the second virtual linear line L2 passing through the stationary curved surface 513 on the cross-section that contains the center axis C of the winding portion 531.

More specifically, the first virtual linear line L1 passes through the inner peripheral edge of a front portion 534 of the winding portion 531; the front portion 534 of the winding portion 531 is arranged to radially face the stationary inside portion 512. The second virtual linear line L2 passes through the front end of the front portion 534 of the winding portion 531.

Other configuration of the electromagnetic relay device 1 of the second embodiment is identical to the corresponding configuration of the electromagnetic relay device 1 of the first embodiment. In the second and subsequent embodiments, reference characters that are the same as those used in the previous embodiments denote the same or corresponding components, unless otherwise specified.

The electromagnetic relay device 1 of the second embodiment is configured such that at least one of the first and second virtual linear lines L1 and L2 passes through the stationary curved surface 513 on the cross-section that contains the center axis C of the winding portion 531. This configuration therefore enables the distance between the joint portion 516 and the winding portion 531 of the electromagnetic relay device 1 to be further shorter, making it possible to further improve the magnetic efficiency of the electromagnetic relay device 1 of the second embodiment.

The other advantageous effects of the electromagnetic relay device 1 of the second embodiment are substantially identical to those offered by the electromagnetic relay device 1 according to the first embodiment.

### Third embodiment

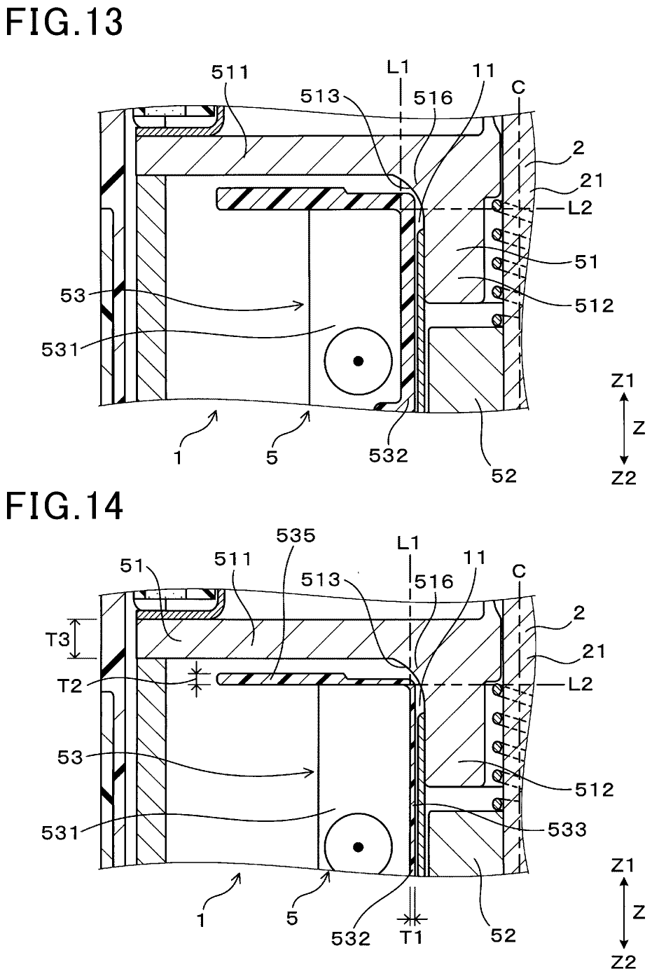

As compared with the electromagnetic relay device 1 of the second embodiment, the area of the stationary curved surface 513 formed on the joint portion 516 according to the third embodiment is, as illustrated in FIG. 13, greater than that according to the second embodiment.

As illustrated in FIG. 13, both the first and second virtual linear lines L1 and L2 pass through the stationary curved surface 513 on the cross-section that contains the center axis C of the winding portion 531.

Other configuration of the electromagnetic relay device 1 of the third embodiment is identical to the corresponding configuration of the electromagnetic relay device 1 of the second embodiment.

The electromagnetic relay device 1 of the third embodiment is configured such that both the first and second virtual linear lines L1 and L2 pass through the stationary curved surface 513 on the cross-section that contains the center axis C of the winding portion 531. This configuration therefore enables the distance between the joint portion 516 and the winding portion 531 of the electromagnetic relay device 9 to be still further shorter, making it possible to still further improve the magnetic efficiency of the electromagnetic relay device 1 of the third embodiment.

The other advantageous effects of the electromagnetic relay device 1 of the third embodiment are substantially identical to those offered by the electromagnetic relay device 1 according to the second embodiment.

### Fourth embodiment

As compared with the electromagnetic relay device 1 of the third embodiment, the thickness of the bobbin 532 of the electromagnetic relay device 1 according to the fourth embodiment is smaller than that according to the third embodiment.

As illustrated in FIG. 14, the tubular cylindrical portion 533 of the bobbin 532 according to the fourth embodiment has a thickness T1 and the plate member 511 has a thickness T3. The thickness T1 of the tubular cylindrical portion 533 of the bobbin 532 is smaller than the thickness T3 of the plate member 511. For example, the thickness T1 of the tubular cylindrical portion 533 of the bobbin 532 is less than or equal to half of the thickness T3 of the plate member 511. As another example, the thickness T1 of the tubular cylindrical portion 533 of the bobbin 532 is less than or equal to one-third of the thickness T3 of the plate member 511.

The bobbin 532 has a front flange 535 that has an annular shape and extends radially outside the first end thereof. The front flange 535 of the bobbin 532 is arranged to cover the winding portion 531 from the front side of the winding portion 531. The front flange 535 has at least partially a thickness T2. The thickness T2 of the front flange 535 is smaller than the thickness T3 of the plate member 511. For example, the thickness T2 of the front flange 535 is less than or equal to half of the thickness T3 of the plate member 511. As another example, the thickness T2 of the front flange 535 is less than or equal to one-third of the thickness T3 of the plate member 511.

Other configuration of the electromagnetic relay device 1 of the fourth embodiment is identical to the corresponding configuration of the electromagnetic relay device 1 of the third embodiment.

The thickness T1 of the tubular cylindrical portion 533 of the bobbin 532 according to the fourth embodiment is less than or equal to half of the thickness T3 of the plate member 511. This enables the stationary core 51 to be further closer to the winding portion 531, making it possible to still further improve the magnetic efficiency of the electromagnetic relay device 1 of the fourth embodiment.

The thickness T2 of the front flange 535 of the bobbin 532 according to the fourth embodiment is less than or equal to half of the thickness T3 of the plate member 511. This enables the stationary core 51 to be even closer to the winding portion 531. The thickness T2 of the front flange 535 of the bobbin 532, which is relatively thin, enables the length of the winding portion 531 to be longer in the reciprocation direction Z. This therefore enables the number of turns of the conductive wire of the winding portion 531 to be greater.

Consequently, the electromagnetic relay device 1 of the fourth embodiment makes it possible to still further improve the magnetic efficiency of the electromagnetic relay device 1 of the fourth embodiment.

The other advantageous effects of the electromagnetic relay device 1 of the fourth embodiment are substantially identical to those offered by the electromagnetic relay device 1 according to the third embodiment.

The present disclosure is not limited to the above-described embodiments, and can be variably modified within the scope of the present disclosure.

While the illustrative embodiments of the present disclosure have been described herein, the present disclosure is not limited to the embodiments and configurations described herein. Specifically, the present disclosure can include any and all modified embodiments and modifications within the range of equivalency of the present disclosure. Additionally, various combinations of the embodiments, modified combinations to which at least one element has been added, or modified combinations from which at least one element has been eliminated are within the scope of the present disclosure and/or the patentable ideas of the present disclosure.

1. An electromagnetic relay device comprising:
a movable member including a movable contact movable to abut onto and separate from a stationary contact;
a plunger configured to cause the movable member to reciprocate to accordingly cause the movable contact to abut onto or separate from the stationary contact; and
a solenoid unit configured to cause the plunger to reciprocate in a predetermined reciprocation direction,
the solenoid unit comprising:
an electromagnetic coil that includes a winding portion comprised of a wound conductive wire, the winding portion being configured to generate magnetic flux when energized;
a stationary core that includes a through hole through which the plunger is arranged to pass and that is located inside the magnetic coil; and
a movable core arranged behind the stationary core and fixed to the plunger,
wherein:
the stationary core and the movable core constitute a magnetic path of the magnetic flux generated by the energized winding portion;
the movable core is configured to reciprocate with respect to the stationary core when the winding portion is energized;
the stationary core includes a plate member located in front of the electromagnetic coil, the plate member having a rear-side surface and being arranged to overlap the electromagnetic coil when viewed in the reciprocation direction;
the stationary core has a stationary inside portion located inside the electromagnetic coil, the stationary inside portion having an outer peripheral surface;
the plate member and the stationary inside portion are integrated with each other;
the electromagnetic coil and the stationary core are arranged to form a clearance therebetween; and
the stationary core has a joint surface between the outer peripheral surface of the stationary inside portion and the rear-side surface of the plate member, the joint surface being curved convexly with respect to the plunger to constitute a stationary curved surface.

2. The electromagnetic relay device according to claim 1, wherein:
a first virtual linear line is defined as a linear line on a cross-section that contains a center axis of the winding portion around which the conductive wire is wound, the first virtual linear line passing through an inner peripheral edge of the winding portion in parallel to the reciprocation direction;
a second virtual linear line is defined as a linear line on the cross-section, the second virtual linear line passing through a front end of the winding portion in orthogonal to the reciprocation direction; and
the electromagnetic relay device is configured such that at least one of the first and second virtual linear lines passes through the stationary curved surface on the cross-section.

3. The electromagnetic relay device according to claim 2, wherein:
the electromagnetic relay device is configured such that both the first and second virtual linear lines pass through the stationary curved surface on the cross-section.
